(19) United States
(12) Patent Application Publication
(10) Pub. No.: US 2008/0265590 A1
(43) Pub. Date: Oct. 30, 2008

(54) DOOR STRIKE AND INSTALLATION METHOD

(75) Inventors: Jerry B. Bodily, Denver, CO (US); Troy Dalsing, Kinston, NC (US)

Correspondence Address: MICHAEL BEST & FRIEDRICH LLP, 100 E WISCONSIN AVENUE, Suite 3300, MILWAUKEE, WI, 53202, US

(73) Assignee: Schlage Lock Company, Carmel, IN (US)

(21) Appl. No.: 11/741,505

(22) Filed: Apr. 27, 2007

(51) Int. Cl. E05B 15/02

(52) U.S. Cl. 292/340; 29/700

(57) ABSTRACT

A door strike construction and installation method is provided for aid in locating and installing a door strike in a door frame. The door strike of the present invention comprises a strike plate for coupling to a door frame, an opening in the strike plate adapted for receiving a door latch bolt, a dust box coupled to the strike plate at a boundary or perimeter of the opening and adapted to receive the door latch bolt, and one or more center point apertures formed on a generally flat, innermost portion of the dust box and positioned to provide center points for marking one or more positions for drilling into the door frame to provide a space for receiving the dust box and installing the dust box in the door frame.

### BACKGROUND

This invention relates to door strikes and installation methods for door strikes.

### SUMMARY

Conventional door hardware includes a door lock, whether of the latch or deadbolt type, and a cooperating door strike mounted on a doorjamb. In the most common arrangement, the door strike is a simple stamped metal plate with an aperture of suitable size and shape. In a typical arrangement, the strike is mounted to the doorjamb using wood screws that are fixed.

One of the problems faced by the door lock installation industry concerns preparation of the door frame or door jamb for receiving a door strike. In current practice, installers or carpenters often use a chisel and/or drills to hollow-out a location where the door strike is to be positioned. Thus, each installation is essentially a customized operation.

For the door lock and the door strike to work properly, it is essential that the lock or deadbolt fit perfectly in the hole or aperture of the door strike. If either the strike or the lock are out of position and do not mate correctly, the door will not close properly. Possible malfunction can be caused by misalignment of the door lock and door strike. Typically, the lock is mounted on the door first and then the door strike is located on the doorjamb so that it matches as closely as possible to the lock. Therefore, a need has been recognized among door lock manufacturers to properly position the door strike. Some manufacturers have chosen to provide a paper template to aid in installation. However, there can be some uncertainty when using paper templates. The positioning of the paper template itself is important and requires skill on the part of the installer.

It has also been found to be an advantage to equip a door strike with a compartment or box-like structure coupled to the door strike and sunk into the door frame or door jamb as a receptacle to the latch or deadbolt. This compartment is often called a dust box or a strike box or a deep mortise liner. The most common term is dust box. One of the reasons for calling it a dust box is it does assist in preventing dust or dirt from entering into the area and gives a clean, reliable properly configured portion for holding the deadbolt or latch in place.

For all of these reasons it is become increasingly important to properly locate the door strike and the dust box on the door frame or door jamb.

### SUMMARY OF THE INVENTION

The present invention is directed to a door strike incorporating a dust box with a structure that incorporates a means for easily and properly positioning the door strike on the door frame or doorjamb. The door strike comprises a strike plate for coupling to a door frame, an opening in the strike plate adapted for receiving a door latch bolt, a dust box coupled to the strike plate at the boundary of the opening in the strike plate and adapted to receive the door latch bolt. The dust box is provided with one or more center point apertures on a generally flat, innermost (in respect to the door frame) portion of the dust box. The center point apertures are positioned to provide center points for marking one or more positions for assisting the installer to position drills for receiving the dust box. The invention may incorporate two or more center point apertures that may be positioned in alignment with each other and may also be positioned on a center line of the generally flat, innermost portion of the dust box. The door strike may also incorporate one or more attachment member apertures in the generally flat, innermost portion of the dust box, the attachment member apertures being positioned to accommodate one or more door strike attachment members, such as wood screws.

The door strike may also incorporate one or more strike plate attachment member apertures for the purpose of accommodating one or more strike plate attachment members, such as wood screws, to attach the strike plate to the door frame.

In a method of installing the door strike, the door lock is installed into the door itself. The door lock then provides means for the installer to locate on the door frame the general position of the door strike for receiving the deadbolt or door latch. The dust box is positioned on the door frame by physically placing the generally flat, innermost portion of the dust box on the door frame or door jamb in the proper position opposite the deadbolt or door latch. The installer uses the center point apertures as a locating device for marking the center line of a door jamb preparation. Simultaneously, with these markings the installer then has properly marked the position for a center point of a drill used to drill into the door frame to create the proper opening for the dust box.

### BRIEF DESCRIPTION OF THE DRAWINGS

FIG. 1 is an elevation view of a typical door panel and door frame construction utilizing a lock strike construction pursuant to the present invention, portions of the figure being broken away to reduce its size.

FIG. 2 is an isometric perspective view showing an exploded form of the door strike of the present invention.

FIG. 3 is a front view of an embodiment of the door strike of the present invention.

FIG. 4 is an isometric perspective view of the embodiment of the invention shown in FIG. 3.

FIG. 5 is an isometric perspective view of a front side of the embodiment of the invention shown in FIG. 3.

FIG. 6 is a side view of the embodiment of the embodiment of the invention shown in FIG. 3.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

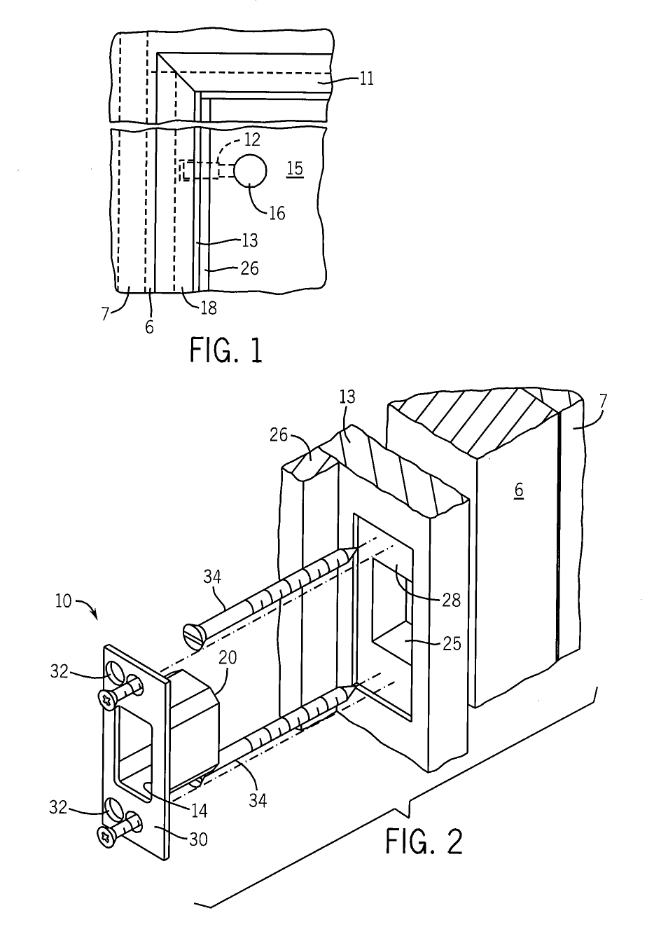

Referring first to FIG. 1, this figure is provided to show a typical door structure that is appropriate for use of the present invention. In the arrangement shown in FIG. 1, there is provided as part of a frame for a door, a cripple 6. This is a piece of wood usually about 2″×4″ or 2″×6″ in cross-sectional dimension, extending in an upright fashion. The cripple is often augmented by a stud 7 of similar dimensions. The stud is generally disposed vertically, immediately adjacent to and usually fastened to the cripple.

Disposed alongside the cripple is a door frame 11 customarily made of wood. Included in the door frame is a door side rail 13. This is a generally upright-flat rectangular wooden member perhaps 1″×6″ or 1″×8″. The door side rail 13 is disposed with respect to the cripple 6 at a distance to afford an intervening space. While the space does not always occur and may vary in size, it is usually present because the door opening is framed much larger than the door casing itself. This allows for the interposition of wedges and/or shims so that precisely made door frames can be accurately positioned both vertically and horizontally within the raw framing. It is customary to supplement the rail 13 with trim members 18 for finishing purposes. The trim members 18 are not expected to impart any particular strength to the construction.

A door or door panel 15 is generally movably positioned within the opening and is partially framed by the door side rail 13. The door or door panel 15 is mounted by hinges so as to be movable toward and away from a door stop 26 extending vertically and fastened to the door frame side rail 13. The stop is centered so that the door panel is offset to one side. In the door panel is disposed a lock mechanism 16 including a door latch 12, formed either as a deadbolt or as a latch bolt, which can be movably retracted in a position to be substantially flush with the edge of the door panel and alternately assume a projected position extending for approximately ¾″ or 1″ from an outer edge of the door panel 15.

It is customary to provide at least a recess or mortise 25 in the door side rail 13 (which is a part of the door frame) deep enough for reception of the door latch bolt 12. Typically, the door latch bolt is rectangular and vertically elongated, and to accommodate it easily and to provide for vertical sag, the mortise 25 is vertically extended and is symmetrical about a vertical axis. Such a mortise can be used alone but customarily has a rather shallow surrounding mortise to receive a door strike 10 and particularly the portion of a door strike known as a strike plate 30. This plate 30 has a central, vertically elongated opening 14 therein which is symmetrical about a vertical axis, about which the remainder of the plate is likewise symmetrical. Typically, the strike plate 30 carries a pair of counter-sunk or beveled or conical strike plate attachment member apertures 32 which may be screw holes, usually disposed on a an axis and above and below the opening 14. The attachment member aperture can be position along an axis offset from a centerline of the strike plate or they can be positioned on the centerline. If the attachment member apertures are positioned on an axis offset from the centerline, additional aperture for additional supporting members may be positioned on the centerline.

Referring to both FIGS. 1 and 2, it can be readily appreciated that the positioning of the door strike 10 and the mortise 25 is critical. These two structures must be properly positioned and aligned so that the door 15 will properly close, the latch bolt 12 will be properly aligned with the opening 14, and ultimately the door latch bolt 12 will enter the opening 14 and in a fully extended position, properly lock the door 15 and prevent it from being opened. In FIG. 1, there is a dashed outline showing a door latch bolt 12 extended into the door frame to provide a locked door 15.

Historically, installers have used a variety of means to position a door strike 10 on the door frame during installation. While some installers simply “eyeball” the installation position, many installers use templates provided by manufacturers of door locks and door strikes. Templates have become a valuable aid in installation processes; however, positioning of templates is critical and time consuming.

Typically, while using templates or other positioning indication means, the installer will locate a center point or center points for a drill utilized to drill into the door side rail 13 portion of the door frame 11. The installer uses a single drill or multiple drills to form a round opening or openings in the door side rail 13 at approximately the correct depth for receiving the door strike 10. After the holes are drilled, installers commonly use a chisel to hollow out the location where the door strike is to be positioned. Thus, each installation is essentially a customized operation.

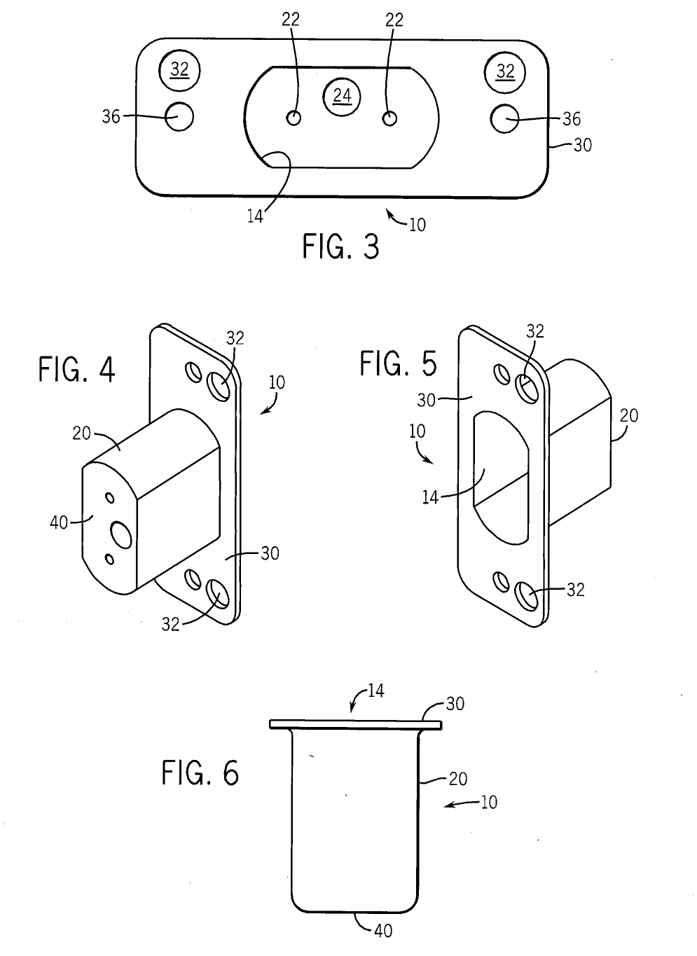

Referring now to FIGS. 3, 4, 5 and 6, a number of views of the door strike 10 of the present invention is shown. The door strike 10 incorporates a dust box 20 coupled or connected to a strike plate 30 at a boundary or perimeter of an opening 14 adapted to receive the door latch bolt 12. The dust box is also known by other names such as a strike box or deep mortise liner. The primary purpose of the dust box 20 is to provide a receptacle or positioning structure for the door latch bolt 12. However, in the present invention, the dust box 20 is additionally provided with a means to position and mark a center point or center points for positioning a drill for drilling into the door frame to provide the opening for receiving the dust box. In FIGS. 3-6, it can be readily appreciated that center point apertures 22 are positioned along a center line of the opening 14 or dust box 20. The center point apertures 22 are positioned along a central line for the purpose of providing a marking point so that when an installer uses a drill to drill into the door frame at that center point, a cavity is created in the door frame which is properly positioned and centered for receiving the dust box 20 in the proper position of the door frame.

In one embodiment of the invention, the center point apertures 22 are positioned along the center line of the opening and the center line of the dust box and are spaced so as to be the same distance from an outer curved edge of the dust box 20 such that when round holes are drilled into the door frame, an outer boundary in the door frame is already created and provided for receiving and positioning the door strike and dust box 20. It can be readily appreciated by those skilled in the art that after a pair of holes are drilled, a minimum of chiseling or additional forming operations are required to form a proper size and shape opening in the door frame to receive and position the door strike.

It can readily be appreciated that the center point apertures 22 are positioned on a generally flat, innermost portion 40 of the dust box 20. From the perspective of FIG. 3, this portion 40 is a bottom portion of the dust box. In respect to the door frame 11 or opening 14, the portion 40 is the innermost portion. This is an ideal part of the dust box for assisting the installer in easily positioning the door strike 10 and dust box 20 on the door side rail 13 prior to any drilling or mortise-creating procedure. The door strike 10 can be easily held in the proper position with one hand while using the other hand to mark drilling points through center point apertures 22 on the surface of the door side rail portion of the door frame.

After marking drilling point center points through the center point apertures 22, the installer can move the door panel 15 and door latch bolt 12 into position opposite the center point markings on the door side rail 13. The installer can then check the accuracy of the positioning marks prior to actual drilling operation.

After the installer drills one or more holes through the center point aperture or apertures 22, the installer may use other tools, such as chisels, to properly form an opening in the door side rail 13 to receive the structure of the dust box 20. The door strike 10 and dust box 20 are then positioned in the opening in the door side rail 13 and an outline can be drawn around an outer perimeter of the door strike 10 to provide the installer with an outer boundary for marking the outer perimeter of the door strike 10 on the door side rail 13. The installer can then use a chisel or some other tool to form a mortise or vertically elongated depression symmetrical with an axis of the dust box and door strike 10. After the mortise is completed, this will remove material of the side rail 13. However, the door side rail 13 is not substantially relied upon for strength so that the removal of additional material in the door side rail 13 is not of any significant consequence.

At this stage, typically the installer then installs the door strike 10 and dust box 20 into the opening provided in the door side rail 13 and the strike plate 30 is positioned properly on and into the portion of the door side rail 13.

The installer can then mark positions of one or more strike plate attachment members 34 through strike plate attachment member apertures 32. Commonly, door strikes 10 may also be provided with additional attachment apertures 36 for either structural or decorative purposes. Attachment members such as brass screws can be provided in these apertures for primarily decorative reasons.

Additionally, the innermost, generally flat portion 40 of the dust box is also provided with an attachment member aperture 24 for receiving an attachment member such as a wood screw.

While in practice, uniform results of positioning and installing the door strike 10 cannot always be guaranteed because of variables such as the character of the wood, grade of workmanship, operational history of installation and the like, the present invention nevertheless provides a convenient improvement in the installation process of a door strike 10. Furthermore, this is accomplished without any change from accepted customary appearance and procedure, without requiring unusual expertise and workmanship, without requiring exotic or unusual tooling and with only minimal instructions to the installer.

Thus, the invention provides, among other things, a means and method for locating a door strike. Various features and advantages of the invention are set forth in the following claims.

What is claimed is:

1. A door strike comprising:
a strike plate for coupling to a door frame;
an opening in the strike plate adapted for receiving a door latch bolt;
a dust box coupled to the strike plate at a boundary of the opening and adapted to receive the door latch bolt; and
one or more center point apertures formed on a generally flat, innermost portion of the dust box and positioned to provide one or more center points for marking one or more locations for drilling into the door frame to provide a space in the door frame for receiving the dust box.

2. The door strike of claim 1, wherein two or more center point apertures are provided on the generally flat, innermost portion of the dust box and are positioned in alignment with each other.

3. The door strike of claim 2, wherein the center point apertures are positioned on a centerline of the opening in the strike plate of the door strike.

4. The door strike of claim 3, wherein the center point apertures are positioned equidistant from an outer curved perimeter of the opening in the strike plate.

5. The door strike of claim 4, wherein one or more attachment member apertures are provided on the generally flat, innermost portion of the dust box, the attachment member aperture being provided to accommodate one or more door strike attachment members to attach the dust box to the door frame.

6. The door strike of claim 5, wherein one or more strike plate attachment member apertures are provided in the strike plate for the purpose of accommodating one or more strike plate attachment members to attach the strike plate to the door frame.

7. The door strike of claim 1, wherein the generally flat, innermost portion of the dust box is provided with outwardly projecting bumps centered on the one or more center point apertures of the dust box such that the bumps can be utilized to mark positions for drilling.

8. The door strike of claim 5, wherein the one or more attachment member apertures are centered on bumps formed on an outer side of the generally flat, innermost portion of the dust box such that the bumps can be utilized to mark positions for drilling.

9. A door strike comprising:
a strike plate for coupling to a door frame;
an opening in the strike plate adapted for receiving a door latch bolt;
a dust box coupled to the strike plate at the boundary of the opening and adapted to receive the door latch bolt; and
one or more center point bumps formed on a generally flat, innermost portion of the dust box and positioned to provide center points for marking one or more positions for drilling into the door frame to provide a space for receiving the dust box.

10. A door strike comprising:
a door strike place for coupling to a door frame;
an opening in the door strike plate adapted for receiving a door latch bolt;
a dust box coupled to the door strike plate at the boundary of the opening and adapted to receive the door latch bolt; and
a plurality of center point apertures formed on a generally flat, innermost portion of the dust box and positioned in alignment with each other along a center line of the opening in the strike plate of the door strike for the purpose of marking one or more locations for drilling into the door frame to provide a space in the door frame for receiving the dust box.

11. The door strike of claim 10 wherein the center point apertures are positioned equidistant from each other and equidistant from an outer curved perimeter opening in the strike plate.

12. The strike plate of claim 10 wherein one or more attachment member apertures are additionally provided on the generally flat, innermost portion of the dust box, the attachment member apertures being provided to accommodate one or more door strike attachment members to attach the dust box to the door frame.

13. The door strike of claim 11 wherein one or more strike plate attachment member apertures are provided on the strike plate, the strike plate attachment member apertures being provided to accommodate one or more door strike plate attachment members to attach the door strike to the door frame.

14. A door strike comprising:
a door strike plate for coupling to a door frame;
an opening in the strike plate adapted for receiving a door latch bolt;
a dust box coupled to the door strike plate at a boundary of the opening and adapted to receive the door latch bolt;
one or more center point apertures formed on a generally flat, innermost portion of the dust box and positioned in alignment with each other on a center line of the opening of the strike plate of the door strike to provide one or more center points for marking one or more locations for drilling into the door frame to provide a space in the door frame for receiving the dust box, wherein the center point apertures are positioned equidistant from each other and equidistant from an outer curved perimeter of the opening in the strike plate;
one or more attachment member apertures are additionally provided on the generally flat, innermost portion of the dust box, the attachment member apertures being provided to accommodate one or more door strike attachment members to attach the dust box to the door frame; and
one or more strike plate attachment member apertures are provided in the strike plate for the purpose of accommodating one or more strike plate attachment members to attach the strike plate to the door frame.

15. A method of installing a door strike to a door frame comprising:
providing a strike plate for the door strike, the door strike having a flat portion for coupling to a door frame;
providing an opening in the strike plate adapted for receiving a door latch bolt;
providing a dust box coupled to the strike plate at a boundary of the opening and adapted to receive the door latch bolt;
providing one or more center point apertures formed on a generally flat, innermost portion of the dust box and positioned to provide one or more center points of the opening in the strike plate;
locating the generally flat, innermost portion of the dust box on the door frame at a position that is appropriate for receiving the door latch bolt;
marking the locations of the center point apertures on the door frame to provide locations for drilling into the door frame to provide a space in the door frame for receiving the dust box; and
utilizing the marked center points for the purpose of forming the opening in the door frame to receive the dust box.
